(19) United States
(12) Patent Application Publication
(10) Pub. No.: US 2004/0194272 A1
(43) Pub. Date: Oct. 7, 2004

(54) Arrow head saver

(76) Inventor: Bart Harold Roberts, Ogden, UT (US)

Correspondence Address: Bart Harold Roberts, 1040 Rushton, Ogden, UT, 84401, US

(21) Appl. No.: 10/407,961

(22) Filed: Apr. 4, 2003

(51) Int. Cl. B23P 19/04

(52) U.S. Cl. 29/254

(57) ABSTRACT

This device is called the “Arrow Head Saver” and is used to extract several different types of arrow heads such as but not limited to broad heads with 2,3, and 4 blades, and mechanical broad heads. Both types are used for hunting many different types of animals. It also works on field point tips which are used for target practice and the like.

This device has a handle, which swivels for convenience and can be made of several different materials, and is attached to steel, aluminum, brass, composite, fiberglass, titanium, or any other metal rod which will slide through a thick wall tube that has a 1/4 inch hole for what is called the slide hammer which slides along the rod after it is attached to the arrow head tip and strikes the handle which will eventually extract the arrow head tip.

### BACKGROUND OF INVENTION

This invention relates to arrows or spears or bolts that use a threaded arrow head tip. This invention is intended to extract arrow head tips from wood, fiberglass, bone, metal, rubber, and the like by means of a slide hammer striking a handle which forces out the arrow head tip from where it is lodged. This invention is for archery hunters, archery target practice, atlatl, cross bow users or anyone who has lodged an arrow head tip into any surface.

### DESCRIPTION OF THE PREFERRED EMBODIMENT

Referring to FIG. 1, there is indicated at 1 a slide hammer which can be made of several heavy materials which is a tubular type striker which has a ¼ inch hole 3 through it which slides on a rod 2 which can be made of metal, aluminum, fiberglass, titanium and the like. The rods 2 can be attached to one another by male 4 and female 5 threads to accommodate a longer rod 2 which will give the slide hammer 1 a greater impact as you push it by hand to the impact plate 6 which is attached to the swiveling handle 7 which can be different types forcing the “arrow head saver” the direction of impact which in turn will force out the lodged arrow head tip 9 as shown in FIG. 2 which is threaded into the end of the “arrow head saver” 12. As shown in FIG. 2 the arrowhead tips are threaded onto the tip 12 of the rods 2 after the slide hammer 1 has been slid onto the rods 2. The slide hammer 2 is forced by your hand toward the striking plate 6 attached to the handle 7 which will force the “arrow head saver” in that direction which will (after which could take several attempts) force out the lodged arrow head tip 9.

### BRIEF DESCRIPTION OF DRAWINGS

FIG. 1 is a look at the invention while it is took apart to place in a case for carrying.

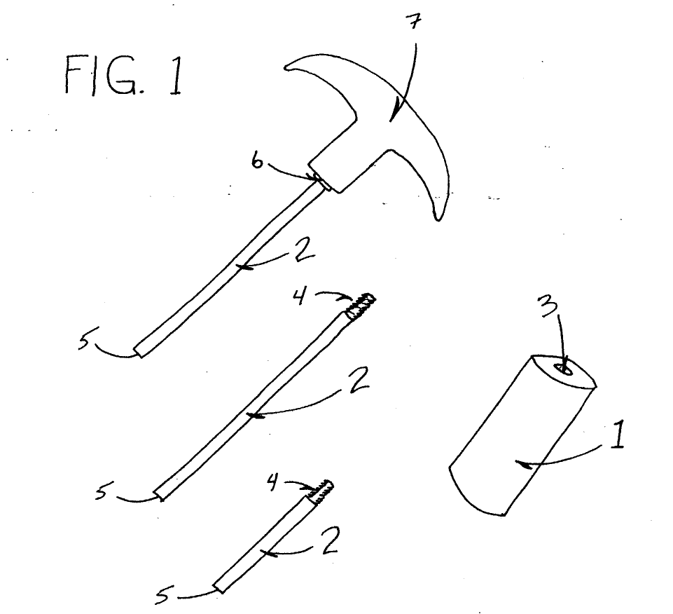

FIG. 2 is the invention put together showing how the slide hammer works, and how the handle swivels. It also shows two types of arrowheads it can extract from where they are lodged.

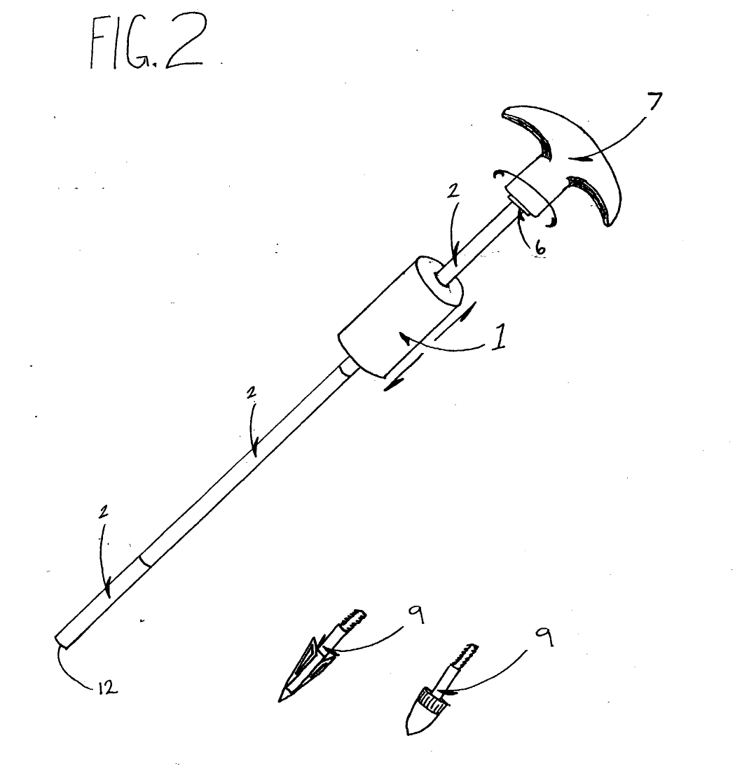

The above summarizes my invention and minor changes there to are possible without detracting

1. A device for extracting varies types of arrowhead points from any surface.

2. The device as mentioned and disclosed in claim #1 is portable and easy to use.

3. A means to extract arrowhead tips from wood, trees, fiberglass, metal, cement, and the like.

4. A device can use two or more pieces with the means to easily extend the length of the device.

5. A method to extract varies arrowhead tips without significantly damaging the arrowhead tip.
